(19) United States
(12) Patent Application Publication
(10) Pub. No.: US 2024/0223834 A1
(43) Pub. Date: Jul. 4, 2024

(54) METHOD AND MEANS FOR PROVIDING MULTI-CONTENT MEDIA

(71) Applicant: Telefonaktiebolaget LM Ericsson (publ), Stockholm (SE)

(72) Inventors: Fredrik Dahlgren, LUND (SE); Alexander Hunt, TYGELSJÖ (SE); Gang Zou, LUND (SE); Sunny Sharma, LIMHAMN (SE); Florent Torres, MALMÖ (SE)

(73) Assignee: Telefonaktiebolaget LM Ericsson (publ), Stockholm (SE)

(21) Appl. No.: 18/557,325

(22) PCT Filed: Apr. 30, 2021
(86) PCT No.: PCT/EP2021/061461

§ 371 Date: Oct. 26, 2023

(51) Int. Cl. H04N 21/2668; H04N 13/30; H04N 13/337; H04N 13/341; H04N 13/344; H04N 21/41

(52) U.S. Cl. CPC H04N 21/2668; H04N 13/337; H04N 13/341; H04N 13/344; H04N 21/4104; H04N 2013/40

(57) ABSTRACT

A media distribution management unit (10) for providing multi-content media to one or more users (2a, 2b, . . . , 2x) is disclosed. The media distribution management unit (10) is configured to: map, in accordance with a respective profile of one or more users (2a, 2b, . . . , 2x), alternative content into a first media stream (S1) comprising main content, and to playback the first media stream (S1) comprising the main content and the mapped alternative content. A method, computer program, computer program products and system are also disclosed.

### TECHNICAL FIELD

The technology disclosed herein relates generally to the field of content distribution and in particular to a media distribution management unit and a method for providing multi-content media to one or more users.

### BACKGROUND

In 3D television depth perception is conveyed to a viewer. There are basically three different types of technologies for accomplishing the 3D effect, that is, how to differentiate which view is seen by a respective eye. A first technology is to wear eyeglasses with colored lenses, one red and one cyan, known as anaglyph glasses and disclosed e.g. in US 20140218410. A second technology is to use polarizing lenses in the glasses and two pictures that are projected from a screen using differently polarized filters. An example of this technology is disclosed e.g. in U.S. Pat. No. 4,967,268. A third technology is to use active-shutter glasses, as disclosed e.g. in U.S. Pat. No. 4,967,268.

These glasses may be battery powered and comprise an electronic shuttering system that opens and closes the left and right lenses in alteration at very high speed. At a certain moment, the left lens is open, and a user is viewing the left-eye image on the screen while the right lens is blocked. A fraction of a second later, the glasses reverse: the right lens opens, the left lens is blocked, and the TV picture changes so that the right eye gets a slightly different image (or “frame”) than the left eye, and then the process reverses again.

Typically, these technologies have been used to provide 3D viewing on 2D screens, e.g. 3D TVs. In such use cases, the left and right eye should see slightly different content and hence the left and the right side of the glasses use either different color filter, different polarized filter, or different phase in active shutter glasses. In prior art, e.g. in U.S. Pat. No. 9,712,811 B2, it has been suggested to use the same type of lens for both eyes in a first pair of glasses and have the different polarization or shutter phase in a second pair of glasses. This enables different content to be visible for a user of the first pair of glasses compared to a user of the second pair of glasses.

U.S. Pat. No. 9,630,091 B2 discloses a pair of glasses wherein each lens has an upper part and a lower part, the upper and lower parts having differently polarized filters. When the user looks through the upper part of the glasses, he will see content for that particular polarization, and when he looks through the lower part of the glasses, he will see content for the other polarization. This allows the user to switch between two different contents.

If the TV set is adapted for multi-content, there are a few other technologies that can be used to separate the images. One way is to use color separation, in which a set of different red, green, blue (RGB) pixels with slight separation between the wavelengths in each color is used. The user wears a pair of glasses that is correlated to one set of RGB pixels. Another way of separating the displayed information from a screen is to use parallax barrier that can be divided to two locations, and still another way is to use a lenticular lens system that can give two or more locations. The latter technique divides the resolution of the screen into the number of users, but the users need to be at a specific position in the room.

In e.g. US2010079585A1, systems are described wherein multiple users watch the same screen (e.g. a TV or a movie theater), but the different users will obtain slightly different content or versions of the content depending on some principles. Different channels are broadcasted to the users, and their glasses select one of the channels at a time. Then either the users can explicitly select (by e.g. a button) which channel to watch, or the system can switch channels depending on certain principles.

In summary, the prior art uses a fixed polarization or shutter phase of the glasses used. In glasses for 3D TV, the glasses are fixed in the sense that left and right lens are set to the different views/contents in order to create a 3D effect for the user. In other systems, the user either selects a pair of glasses for one of the selectable content or the other. This means that users will have to select which of two streams they are seeing, and there is no dynamics in-between.

In order to enable multiple users watching the same screen to individually select and adapt content of e.g. a movie, there is a need for more flexible methods and means for at least one of 2D and 3D viewing.

### SUMMARY

An objective of embodiments disclosed herein is to solve or at least alleviate at least one of the above-mentioned problems.

The objective is according to a first aspect achieved by a media distribution management unit for providing multi-content media to one or more users. The media distribution management unit is configured to map, in accordance with a respective profile of one or more users, alternative content into a first media stream comprising main content. The media distribution management unit is further configured to playback the first media stream, which comprises the main content and the mapped alternative content.

The objective is according to a second aspect achieved by a method for providing multi-content media to one or more users. The method comprises mapping, in accordance with a respective profile of one or more users, alternative content into a first media stream comprising main content. The method further comprises playback of the first media stream, which comprises the main content and the mapped alternative content.

The objective is according to a third aspect achieved by a computer program for providing multi-content media to one or more users. The computer program comprises computer code which, when run on processing circuitry of a media distribution management unit, causes the media distribution management unit to perform a method according to the second aspect. In particular, to map, in accordance with a respective profile of one or more users, alternative content into a first media stream comprising main content, and to playback the first media stream comprising the main content and the mapped alternative content.

The objective is according to a fourth aspect achieved by a computer program product comprising a computer program according to the third aspect, and a computer readable storage medium on which the computer program is stored. The computer readable storage medium may, for instance, be a non-transitory computer readable storage medium.

The objective is according to a fifth aspect achieved by a system comprising a media distribution management unit for providing multi-content media to one or more users according to the first aspect.

These aspects of the inventive concept provide several advantages. For instance, these aspects allow a large number of dynamic alternative views to be shown for individual people in a room, without each of them requiring their own screen. This is enabled while still also enabling the users to share the same basic content. This individualization of shown content provide a far greater flexibility compared to prior art, which either limits the choice of video stream by the choice of glasses in a fixed relation, or by letting the user be able to see both streams.

Compared to prior art, the present disclosure gives, in various aspects and embodiments, many alternatives even in a system having few, even as low as two, channels as well as the support for mandatory user constraints for a safe solution. Given that most future systems are likely to support only a fairly small number of channels, this makes the presented solution, in various embodiments, highly valuable in order to make such systems practical.

Further objectives, features and advantages of the presented embodiments will be apparent upon reading the following description, claims and the accompanying drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

FIG. 1 illustrates schematically an environment in which various embodiments of the present disclosure may be implemented.

FIG. 2 illustrates a simplified block diagram of a media distribution management unit according to various embodiments.

FIG. 3 illustrates a first and second exemplary system setup.

FIG. 4 illustrates a third exemplary system setup.

FIG. 5 illustrates a fourth exemplary system setup.

FIG. 6 is a flowchart showing an exemplary set-up procedure.

FIG. 7 is a flowchart showing an exemplary way of changing an allocated channel.

FIG. 8 illustrates mapping of user-specific content over time.

FIG. 9 is a flowchart showing an exemplary start-up procedure for a user.

FIG. 10 is a flowchart of embodiments of a method providing multi-content media to user.

FIG. 11 is a schematic diagram showing function units of a media distribution management unit according to an embodiment.

FIG. 12 is a schematic diagram showing functional modules of a media distribution management unit according to an embodiment.

FIG. 13 shows an example of a computer program product comprising computer readable means according to an embodiment.

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

Briefly, the present disclosure provides, in various aspects and embodiments, improvements for scenarios wherein multiple users watch the same screen (e.g. a TV), but where the different users may obtain slightly different content and/or versions of the content in dependence on some given principle(s). Typically, there is a limited number of channels and a system is therefore provided, the system being arranged to manage different user-specific and/or group-specific contexts according to non-trivial schemes. The schemes may, for instance, be based on mandatory constraints, selectable constraints, priorities, and/or various other criteria. This provides an important advantage in that the number of required channels for providing highly individualized content may be much smaller compared to prior art solutions. Various constraints may, for instance, depend on a specific user or on key characteristics of a user (e.g. age) instead of being limited to characteristics of the pair of glasses worn by the user, as in the prior art.

In an illustrative example, a number of viewers are watching a movie, some of the which might be kids and should not see nudity in detail. In the same movie, some of the viewers (not necessarily the same) may want to avoid detailed fighting scenes or blood, while still other viewers do not wish to see commercial advertising. Further, some viewers might want additional information relating to a sports event, e.g. a football game. The additional information may, for instance, be about certain players, some statistics and/or replays whereas still other viewers may want other types of additional content. In yet another example, in a crime movie, the different viewers might obtain different clues and then jointly guess who the murderer is, without knowing which clues they do not have, and the others do have. In a game, the players might see the same scenes but with some variations: some might be given the ability to see through walls, some get other clues on where the opponents are. The viewers/players might also get individual scenes when changing gear, e.g. selecting a new rifle, while the others still see the main content, all while watching the same basic content on the same screen.

The provided methods and means may thus be utilized in a number of different scenarios and applications.

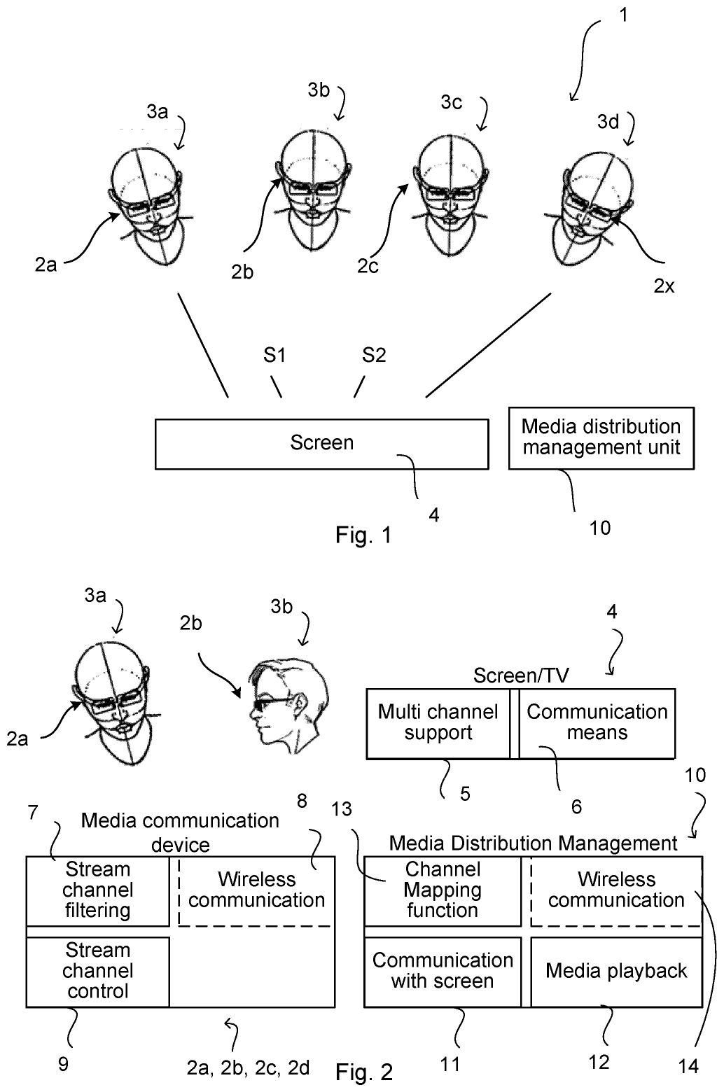

FIG. 1 illustrates schematically an environment in which various embodiments of the present disclosure may be implemented. In particular, embodiments may be implemented in a system 1 to which a number of a media communication devices 2a, 2b, 2c, 2d (here illustrated as glasses 2a, 2b, 2c, 2d) may be connected, for instance by means of Bluetooth, Near Field Communication (NFC) or any other wireless connection. In this example, four users are illustrated as watching a screen 4, e.g. of a TV, each user wearing a respective media communication device 2a, 2b, 2c, 2d. It is noted that there might be fewer or more users 2a, 2b, . . . , 2x. The media communication devices 2a, 2b, 20, 2d may, for instance, have a switchable polarization or switchable active shutter. When the media communication devices 2a, 2b, 2c, 2d are glasses 2a, 2b, 2c, 2d, they may be designed so that both eyes see the same content in 2D, i.e. there need not be a 3D view. This provides an advantage in that less expensive screens can be used.

The system 1 is arranged to support two or multiple streams, e.g. multi-media streams, and the media communication devices 2a, 2b, 2c, 2d may, for instance, be designed to have either two polarizations or two phases of the active shutter mechanism. In the following, a stream combined with a specific media communication device 2a, 2b, 20, 2d (e.g. a pair of glasses) is referred to as a channel. A channel may also be associated with a specific user location in relation to the screen, in which case the media communication device need not comprise a pair of glasses. Instead, the media communication device may comprise a communication functionality for communication with the system 1 and may, in some embodiments, also comprise or be connected to a localization functionality. Such localization functionality may, for instance, comprise a camera arranged e.g. at the screen, by means of which the user may be identified (e.g. by facial recognition means). Another embodiment of the localization functionality comprises the use of a device, e.g. a smartphone having Bluetooth, able to detect an angle of arrival or angle of departure to the user. Such device, e.g. the smartphone or smartwatch, is then able to provide an identification of the user, based on seating knowledge. If glasses are to be used, the media communication device comprises at least the communication functionality and the pair of glasses.

In the scenario wherein the channel is associated with a specific user location, it may be preferred if the user does not require to be able to move while watching. In any of these cases, there is no fixed allocation of a media communication device (e.g. a set of glasses) or direction to the screen to one stream, e.g. a pair of glasses does not have a fixed channel. Instead, there is a media distribution management function in a media distribution management unit 10 that signals to each media communication device 2a, 2b, 2c, 2d which channel it shall make visible. This means that different users 3a, 3b, 3c, 3d can see different alternative content at different times and that channels may be dynamically allocated and re-allocated between users, depending on the respective content to be provided to each user. As noted earlier, four users are illustrated, but there might be fewer or more users and hence also fewer or more media communication device 2a, 2b, . . . , 2x.

Assuming now an example with two channels and four users 3a, 3b, 3c, 3d. When a first, second, third and fourth users 3a, 3b, 30, 3d are watching a movie, all starts following a main first stream S1. Two of the users, the third user 3c and fourth user 3d, might be children, and their settings do not allow them to watch nudity nor scenes comprising violence. Furthermore, the second user 3b might prefer not to see explicit blood or violence but is fine with seeing nudity. In addition, some product placement in the movie may be directed towards adults, such as e.g. wine, beer, or tobacco, whereas other advertisements or product placement are directed towards children. Finally, the first user 3a wants to have sports results flashed when goals are scored in an elite football game being played at the same time, while the others are not interested in receiving such information. Before beginning to watch, each media communication device 2a, 2b, 2c, 2d is registered for a respecting user profile: user profile UP1 for the first user 3a and so on to the fourth user 3d having user profile UP4. There are various ways to implement this. When the movie is started, each user may follow the main first stream S1 on a first channel in their respective media communication device 2a, 2b, 2c, 2d. When there is a nudity scene, the media communication device 2c, 2d of the third and fourth users 3c, 3d are set to switch to a second stream S2, which shows the same movie but with the explicit nudity areas blurred in the second stream S2. After each such scene, these media communication devices 2c, 2d are set to switch back to the first stream S1. At certain occasions, there may be specific product placements or advertisements that might be unwanted or disallowed by certain groups, e.g. alcohol for children, toys for adults, certain types of meat for certain people, etc. According to various embodiments, those advertisements or products are only visible on the alternative channel (i.e. the second stream S2) and the relevant users' media communication device 2a, 2b, 20, 2d are switched to that alternative channel. When there are sports results to show, the results are flashed on the second stream S2 and only the media communication device 2a of the first user 3a are set to switch to the corresponding second channel S2. If that happens simultaneously with alternative content on the second stream S2 which is not only for the first user 3a, the sport flash may be delayed until the second stream S2 is no longer used for any other alternative content for the users 3b, 3c, 3d, and then it can be shown on the second stream S2 only for the first user 3a. Some content may be delayable, whereas other content is time-crucial, i.e. cannot be not delayable. Which content can or cannot be delayed may, typically, depend on the urgency thereof. If there are conflicting needs, e.g. advertisements at the same time as nudity, the media distribution management unit 10 may determine which is the most appropriate allocation of media communication devices 2a, 2b, 2c, 2d to channels depending on priorities. It might be that nudity is never allowed for children whereas the advertisements are seen as less critical. If there are more channels than two available, then different alternative content may be shown simultaneously for two or more users.

The other exemplary user scenarios mentioned above, gaming and sports, can be handled in a similar fashion.

Depending on complexity of the system 1 or on a suitable frame rate, the number of channels may in practice be limited to two. This is the case e.g. for TVs compatible with existing models. More complex TVs and movie theaters, or the like, may be able to handle more channels. If the number of users 3a, 3b, 3c, . . . , 3x is higher than the number of channels, the system 1 may need to schedule individually as well as decide on which channel to show, which channel not to show, which channels can be combined, and which can be delayed. The present disclosure provides a framework and methods for handling this, taking, for instance, mandatory constraints, priorities, suitable combinations, and characteristics of the individualizations into consideration. By delaying content that is delayable, the flexibility of a system, having as few as two channels, may be significantly improved, compared to cases in which all content is or even need to be provided in real time. Furthermore, the present disclosure also provides a practical and secure solution for mandatory constraints.

FIG. 2 illustrates a simplified block diagram of a media distribution management (MDM) unit 10 according to various embodiments.

Two users 3a, 3b watch the same screen 4, and both have a respective media communication device, e.g. each of them wears a respective pair of glasses 2a, 2b. The common screen 4 outputs two different streams S1, S2 according to some mechanism for multi-stream filter support, such as, for instance, polarization or active shutter.

The media distribution management unit 10 controls, in a dynamic manner, which user 3a, 3b shall see which stream S1, S2.

The MDM unit 10 may comprise media playback means 12 for media playback of a first stream S1 with main content and at least on additional, second stream S2 with alternative content. The first and second streams S1, S2 may, for instance, comprise digital video. In some cases, the second stream S2 may comprise only audio. A sport result for instance, may be provided in audio format to a user wearing headphones.

The MDM unit 10 may comprise a channel mapping function 13, which maps the different alternative contents into the different streams S1, S2 depending on the profiles of the respective users (one or more) currently being active.

The MDM unit 10 may further comprise wireless communication means 14 enabling the MDM unit 10 to communicate with the media communication device 2a, 2b, 2c, 2d, e.g. send channel change requests as determined by the channel mapping function 13. The wireless communication means 14 may, for instance, be adapted for Bluetooth, WIFI or 5G. It is noted that the wireless communication means 14 can, in some embodiments, be replaced with a wired connection.

The MDM unit 10 may further comprise communication means 11 for communication with the screen 4. The communication means 11 enables playback on the screen 4 of the two or more streams S1, S2 with the main content as well as the alternative content. The communication means 11 may be wired or wireless.

The MDM unit 10 may be a standalone unit connected to the rest of the system 1, or it may be a function integrated in a media playback unit, which, for instance, may be a set-top box, a gaming console, a video streaming box etc., or it may be integrated in a TV or a screen in a manner similar to the media stream playback function on current TV's.

The Media Distribution Management (MDM) unit 10 comprises at least one of the described function units 11, 12, 13, 14. In an embodiment the MDM unit 10 comprises the communication means 11 for communication with the screen 4 and the wireless communications means 14, while the media playback means 12 and the channel mapping means 13 may be located elsewhere, e.g. in a cloud environment. In such implementations, the MDM unit 10 may then be in wired and/or wireless connection with them.

In a broadest sense, the system 1 comprises at least one function unit 11, 12, 13, 14 of the media distribution management unit 10 and one or more channels. In other, different embodiments, two, three or all four function units 11, 12, 13, 14 are included in the MDM unit 10. In still other embodiments, the screen 4 and/or media communication device 2a, 2b, 2c, 2d are also included in the system 1.

FIG. 2 also illustrates a simplified block diagram of a media communication device 2a, 2b, 2c, 2d, which in the figure is illustrated as glasses 2a, 2b, 20, 2d that may be used in various embodiments and worn by a respective user. Each of the media communication devices 2a, 2b, 20, 2d may, for instance, comprise a stream channel filter support 7. The stream channel filter support 7 may, for instance, comprise means for controlling polarization or an active shuttering mechanism. The stream channel filter support 7 may also simply be a fixed position seating for supporting users having no glasses. In the fixed position seating, each viewer has a certain viewing direction in relation to the screen 4, and the streams are sent in accordance with a user profile set for each fixed position.

The media communication device, in the following exemplified by glasses 2a, 2b, 2c, 2d may further comprise wireless communication means 8, e.g. Bluetooth, in order to be able to communicate with the MDM unit 10 for cases in which the system 1 uses active glasses 2a, 2b, 2c, 2d. Via the wireless communication means 8, a pair of passive glasses may send a request to the MDM unit 10 on a specific stream channel which matches its channel filter setting. The MDM unit 10 may then push the specific stream channel to the passive glasses. Via the wireless communication means 8, an active pair of glasses may receive a specific stream channel configuration from the MDM unit 10. Thereafter it can adjust its channel filter setting so that the user of the glasses can watch the specific stream channel. The wireless communication means 8 is not limited to Bluetooth, and other communication means are also conceivable, e.g. Wifi, NFC or 5G. It is noted that, although it is typically preferred, the communication does not necessarily need to be wireless, cable connections are also conceivable.

The glasses 2a, 2b, 2c, 2d may further comprise a stream channel control 9. The stream channel control 9 receives commands over the wireless communication with the MDM unit 10 and changes the channel(s) by a filtering mechanism accordingly by means of a stream channel filtering 7. The channel change may, for instance, comprise changing polarization or channel for the active shutter mechanism. For cases wherein the glasses 2a, 2b, 2c, 2d are passive, e.g. having fixed polarization or color filter mapping, the stream channel control 9 may be built into the glasses 2a, 2b, 2c, 2d and the MDM unit 10 controls what content is displayed on the respective channels.

The screen 4, e.g. a TV may comprise support for dual (or multiple) channels, denoted multi-channel support 5 in FIG. 2. Such multi-channel support 5 may comprise means as are typically provided in 3D TV's. The dual channel may, for instance, be provided via either polarization or active shutter (alternating frames for the two streams) or resolution divided information such as parallax barrier or lenticular lens systems.

The screen 4 further comprises communication means 6 for enabling communication with the MDM unit 10. The communication means 6 may be wireless or wired, and in some embodiment the MDM unit 10 is integrated into the TV set or screen 4.

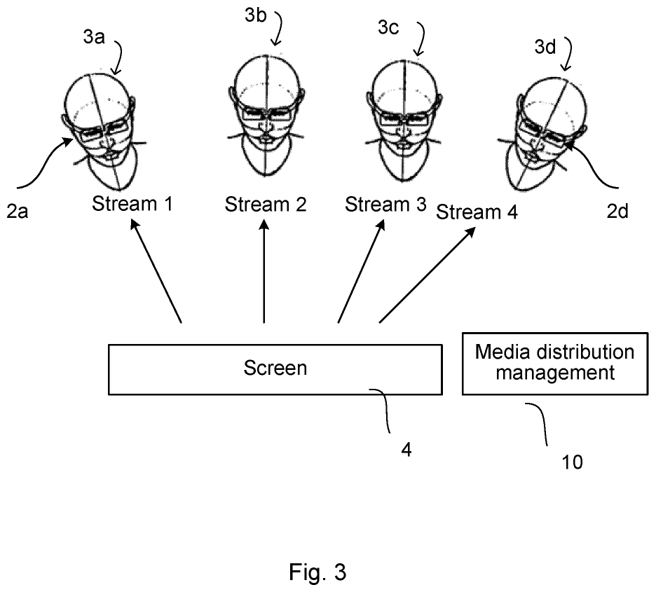

Next different exemplary system 1 setups are described with reference to FIGS. 3, 4 and 5.

In a first scenario, passive glasses are used and the system 1 provides a multi-channel display setup. In the case of passive glasses, e.g. different polarization or different color filter arrangement, the user will have the same arrangement for both the right and left eye. This will allow the system 1 to block one channel for users, e.g. blocking stream 1 for the users with arrangements that is not letting stream 1 information through the glasses.

FIG. 3 illustrates a second exemplary system setup, in which active glasses are used. Active glasses comprise means for adapting and showing information on the screen 4 at a certain time slot. With this setup the active glasses 2a, 2b, 20, 2d and the MDM unit 10 need to be synchronized so that a particular (selected) stream is presented to the respective user 3a, 3b, 3c, 3d and their respective active glasses 2a, 2b, 2c, 2d will either block all information or show all information that is displayed on the screen 4. This is shown in FIG. 3 by each user 3a, 3b, 3c, 3d obtaining a respective stream; Stream 1, Stream 2, Stream 3 and Stream 4.

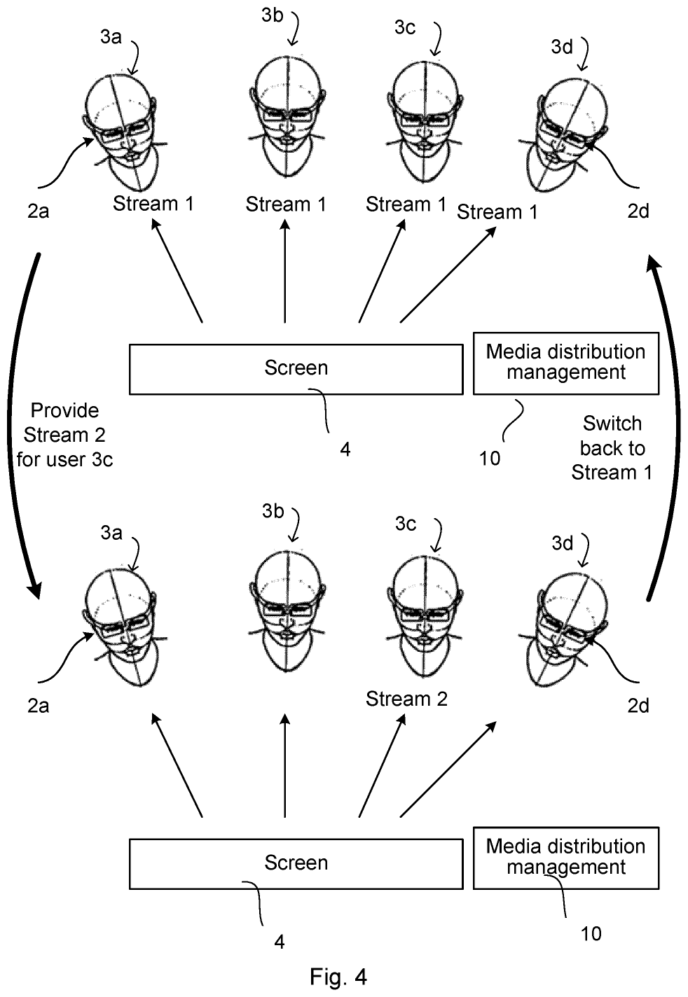

FIG. 4 illustrates a third exemplary system setup. If the information is the same for all users 3a, 3b, 3c, 3d the glasses 2a, 2b, 2c, 2d will let everything through, and all users 3a, 3b, 3c, 3d will see the same stream, Stream 1, as shown in the top part of Error! Reference source not found.. When a user, e.g. the third user 3c, needs a separate stream the MDM unit 10 blocks that screen 4 for all users 3a, 3b, 3c, 3d except the one that is eligible for the information. This is shown in Error! Reference source not found., where all users 3a, 3b, 3c, 3d are watching (receiving) the same stream, until the third user 3 will get more information or different content in a second stream, Stream 2. The third user 3c is the only one that can see this second stream, Stream 2. When the second stream, Stream 2 ends, the MDM unit 10 switches back to the first stream, Stream 1 that all users 3a, 3b, 3c, 3d are able to see.

For the above scenario to function properly, the screen 4 needs to support high switch speed. As a rule of thumb when implementing this, each user requires at least 30 Hz. Hence, if four separate streams are to be supported the screen 4 needs to support 30×4 Hz, i.e. 120 Hz update speed.

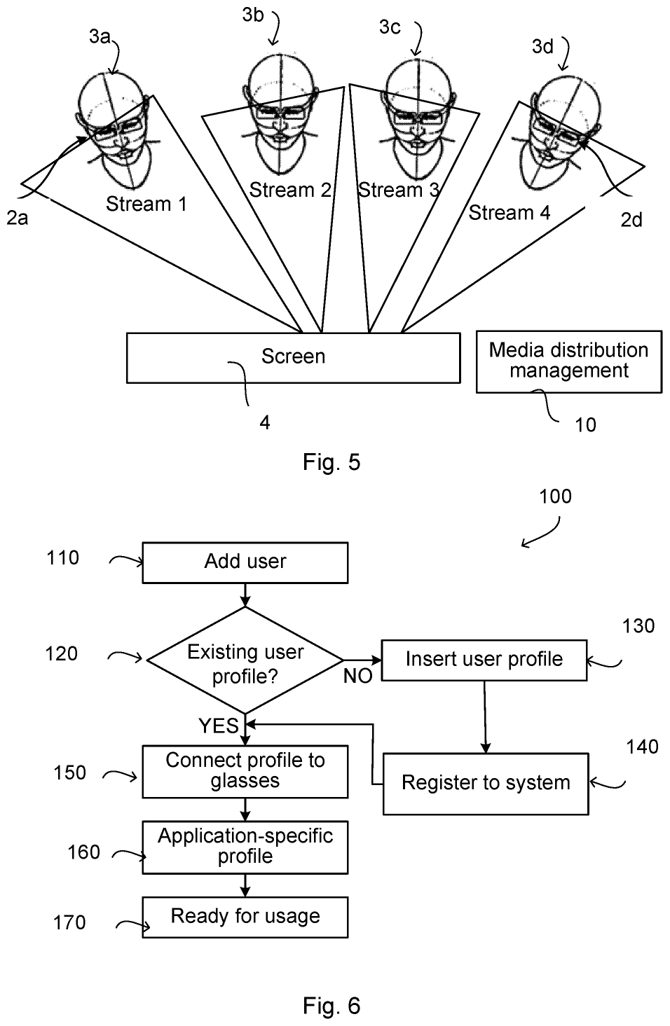

FIG. 5 illustrates a fourth exemplary system setup. In this exemplary scenario, a resolution divided screen is used. When the screen 4 is resolution divided the users 3a, 3b, 3c, 3d need to have dedicated positions in-front of the screen 4, as shown in Error! Reference source not found. by a respective viewing slice, denoted Stream 1, Stream 2, Stream 3 and Stream 4. If the screen 4 supports adaptive resolution dividing, i.e. supports the possibility to switch on and off a parallax barrier system or lenticular lens system, then the setup can be used in the similar way as shown in and described in relation to FIG. 4. In this way most of the time all resolution of the screen 4 is used for all users and occasionally when a user needs private information the system 1 is activated, and the particular stream for this user is activated. The other parts are combined and only a small loss in resolution is removed from the full image.

FIG. 6 is a flowchart showing an exemplary set-up phase rendering a user ready for joining a session. A method 100 for adding a user to a particular session begins in step 110. The flow continues to box 120, in which a check is performed as whether there is has an existing profile for the user. If there is an existing profile in the system 1 for the user, the flow continues to box 150. If there is no existing profile, the flow continues to box 130 wherein a user profile is set up for the user, upon which the profile is registered in the system (box 140). The registering of a profile may be implemented in many different ways. For instance, the user may be requested to input data, e.g. using a keyboard or mobile phone connected to the system, upon which a profile is generated based on the data. As another example, the profile may be selected among a set of pre-stored profiles. As still another example, an application (“app”) may be available on e.g. a mobile device of the user and connected to the system (e.g. over Bluetooth). The user may then input data for or select a profile data using the app of the mobile phone. The flow then continues, from box 120 or box 140, to box 150, wherein the profile is connected to a specific pair of glasses. This pairing of user and a pair glasses can be made in any known manner, for instance by again using an app of the mobile phone. As another example, the glasses may automatically connect to the system 1 when switched on. Next, in box 160, an optional step of applying an application-specific profile is performed. This step can be made for systems 1 supporting several different services, e.g. supporting both showing movies and playing of games. Finally, in step 170, the system 1 is ready for use and the user may put on his pair of glasses and, for instance, start watching a movie or start gaming.

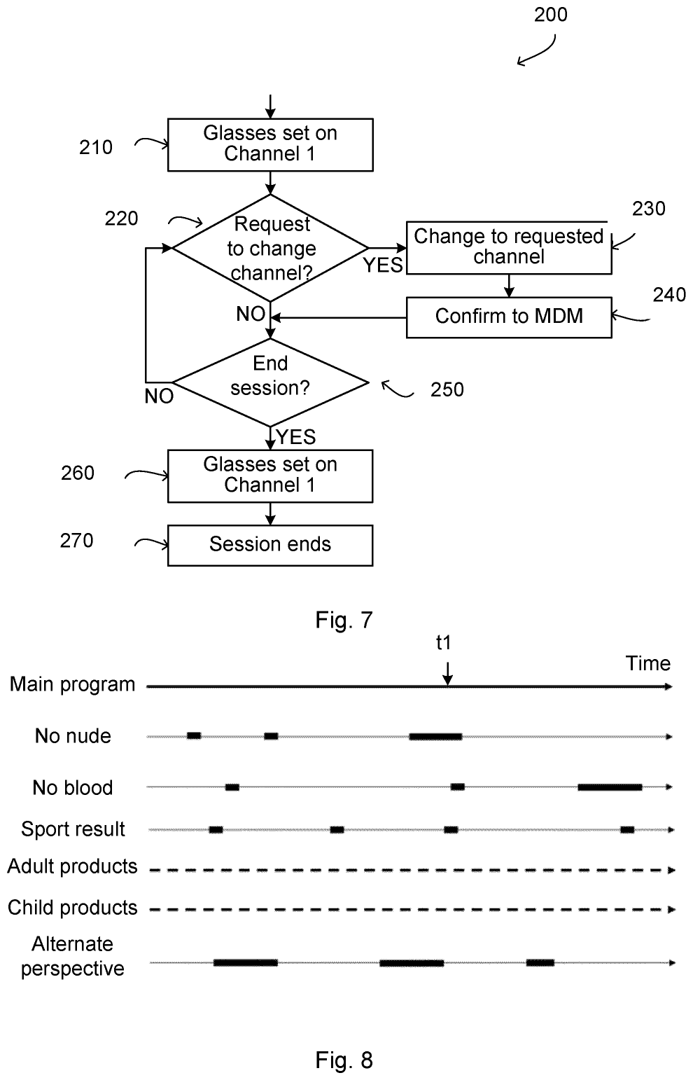

FIG. 7 is a flowchart showing operation of a pair of glasses during a session, once a user specific profile is available to the system 1, and an exemplary way of changing an allocated channel. A method 200 performed in or for a pair of glasses for making them ready for use is provided. In this example, the system 1 streams a mainstream content on a first channel, Channel 1, and hence all glasses are initially set to this channel. This is illustrated in box 210.

In box 220 a request for change of channel is registered in the MDM unit 10, and a signal is sent to the pair of glasses. When the pair of glasses receives the signal to change its channel (box 230), it changes channel and thereafter confirms (box 240) the change to the MDM unit 10. This confirmation is important, in order for the MDM unit 10 to not start streaming content erroneously, for instance streaming content that belong to a mandatory constraint for a particular user, e.g. by streaming adult content to a child.

In box 260, which is an alternative to box 210, all glasses may be set to automatically switch to the first channel, Channel 1, so the users can all see the same basic content and for example agree on next thing to watch. If the users wish to see more, the flow then reverts to box 220. Else, flow continues to box 270. Thus, only one of boxes 210 and 260 need to be implemented; that is, the glasses may be set to a common channel before or after a session.

In box 270, the flow 200 ends when the session, e.g. a movie, is ended. The session may end immediately, or after the glasses have been automatically switched to the first channel, Channel 1, as described in optional box 260.

FIG. 8 illustrates an example on mapping of user-specific content over time. The system 1 has to manage a complex interleaving on a limited number of channels. A difficulty that may occur in the system 1, when the number of users is higher than the number of channels (e.g. 5 users and 2 channels), is that the number of simultaneous views to be provided might be higher than the number of channels. FIG. 8 exemplifies such case. For instance, at time t1, there is various user-specific content that should be shown simultaneously: nudity should be e.g. blurred, blood should be e.g. blurred, sport results should be added, product placements for adults and children, respectively, should be shown and finally an alternative perspective should be shown. Assuming that the system 1 has two channels and that a main program stream, Stream 1, occupies a first channel, Channel 1. A second channel, Channel 2, may then be used for all the user-specific or group-specific content. If the number of different simultaneous options regarding specific content gets higher than what a simple scheduling scheme may handle, a more advanced scheme is needed.

In the FIG. 8, “Adult products” and “Child products” refer to product placements directed towards adults and children, respectively. Alternative perspective means that the user can get the perspective of another person in the scene that differs from the perspective of the main program stream. This has to be managed in a way that is both compliant to certain mandatory requirements and also practical, and a solution is given next.

User-variable content may be divided into different categories, for instance, one category that is mandatory (must not be violated) and multiple further levels depending on priority of the user-variable content. An example on a set of such categories is given below.
Mandatory, possibly dependent on user information/user category (e.g. age/child)
High priority
Medium priority
Low priority
No priority

Furthermore, the user-variable content can be divided into
Immediate: Cannot be delayed
Delayable: Can be delayed, but might have a “best before” time

Examples on the above comprise: certain content is classified as adult, with different subcategories possible (e.g. nudity, violence). A child must not be allowed to watch any adult content so non-adult would be mandatory, irrespective of subcategories. For an adult viewer, adult content might instead be subject to user preferences and given a priority; one user might prefer to not see violence and then a non-violence alternative stream can be high-priority, while nudity might be preferred for one user (high-priority to see it) or does not matter (no priority). Such priorities are important when a scheduler is to determine how to cluster the different options into a limited set of channels.

Furthermore, alternative content might be separated into Immediate, meaning such alternative content cannot be delayed, or Delayable meaning that the scheduler can postpone a unique content until later when it can be done without disturbing other users. Delayable might have a “best before” time, after which it cannot be scheduled. For example, flashing sports results can be considered medium or low priority for one user, but such content can typically be classified as delayable since it does not have to be shown immediately upon, for instance, a goal being scored. On the other hand, blurring out nudity for a child is classified as Immediate, since it is the same movie content at the same time as the main content but with parts of the scene blurred out or containing some occluding objects.

Advertisements may be considered as being of low priority, and if the producer has provided a large number of different opportunities for product placements or ads these may also be of low priority or even Delayable provided that it can be guaranteed that the target user categories gets a minimum number of views. The actual distribution of a specific advertisement may be delayed if channel restrictions so requires. This provides some flexibility for when to show a specific advertisement to a particular user. Product placements in a particular scene of a movie are typically more time critical than advertisements. That is, while advertisements are typically shown during a commercial break of a move and can therefore be delayed, a product placement cannot be delayed much (if it cannot be placed in many different scenes) as it would risk of being misplaced in the movie or not shown at all. In some embodiments, the scheduler may provide feedback to the advertisement company on the number of views (number of times it has been shown to users) as opposed to ordinary broadcasting advertisement where this is not possible.

The MDM unit 10 is responsible for scheduling content on the available channels. It should always comply to content in priority order but may be configured to combine content of different categories depending on preferences and/or priorities.

In an embodiment, the complex interleaving between channels may be used for an alternative perspective view, as mentioned in relation to FIG. 8. This alternative perspective allows for customized scenes for the audience, depending on the user profile, which may be set accordingly. Customized product placement and ads may then be provided, based on and for different profiles. As an example, consider a movie with an indoor dialogue scene wherein only the audio part is important for the scenario. A user with a profile showing interests in sport could see a detail on running shoes from the room while a user interested in design might see a detail of a lamp. Children might see details of a toy. In this example the audio remains the same for the duration of these alternative perspectives. As these visual scenes are not critical, they could be delayed if needed in order to keep synchronization and prioritization as described earlier. This may also allow feedback to the advertisement provider about the number of people who watched the specific advertisement streams in comparison to classic product placement.

It is noted that the described alternative perspective view(s) may also be used for other use cases. For instance, it is possible to render a movie more interactive for the public. As an example, consider a detective TV show with a particular scenario. At certain times, alternative perspectives are used to show different streams including clues and vision to different users. Therefore, they can discuss all different clues in an effort to solve the investigation.

Another exemplary use case is an alternate scene that depends on age of viewer. As an example, a movie may comprise a sex scene or a violence scene. Adults will see the unchanged scene. A user between 16 and 18 might see some implicit suggestive images but not as explicit as the unchanged scene seen by the adults. A user under the age of 16 years might see a different scene (e.g. product placement). A user under the age of 12 years might see a totally different scene. The sound may be set to change in dependence on the audience present. If there is any one below 18 the original sound volume may be lowered, and additional sound such as, for example, music may be mixed in. The younger the people in the audience are, the more the original music may be lowered, and the additional music may increase in volume. If there is a system enabled to distribute sound in a spatial way the sound experience may be more tightly connected to the video images. There are known systems for distributing sound in a spatial way, that may be used for implementing such features of the present teachings.

In other embodiments, a user under the age of 16 might see a different scene (e.g. product placement) while the audio stream remains unchanged. A user under the age of 12 might see a totally different scene with a different audio stream.

Alternative perspective view may be completed with alternative audio by using customized audio streams for each user. In such case the audio devices may focus audio beams directly to the intended user depending on his/her profile as in the previous example.

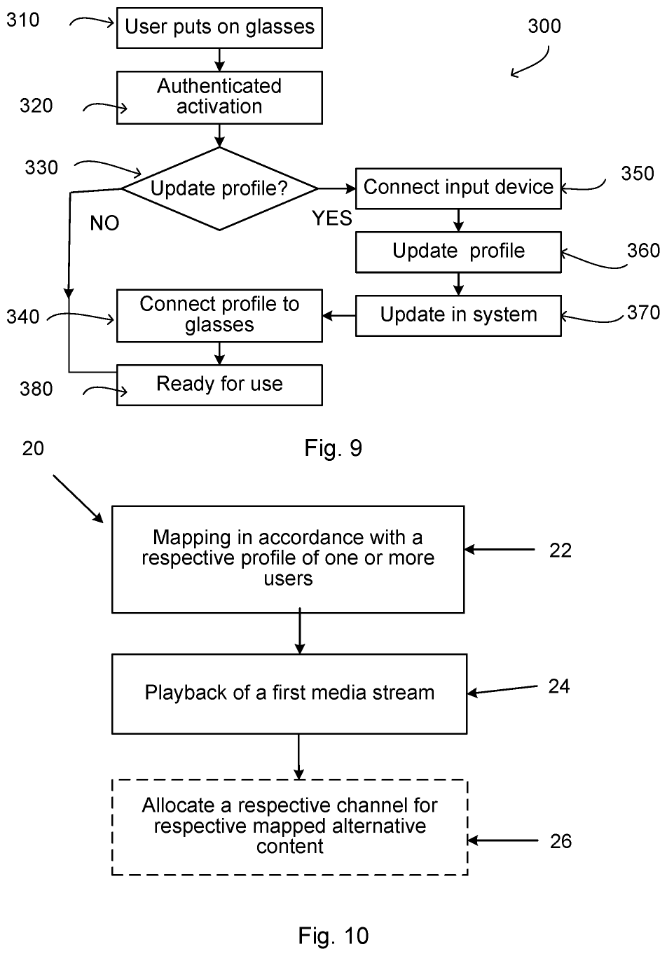

FIG. 9 is a flowchart showing an exemplary start-up procedure for an already added (and registered) user. In a step, illustrated in box 310, a user puts on his glasses. The glasses may have been connected to the user's profile according to the teachings in relation to FIG. 6, see e.g. box 150. When the glasses are put on, the user has to activate the glasses via an authentication process. One approach is to have a fingerprint sensor on the glasses, the fingerprint is captured and sent to the MDM unit 10 for user authentication. Another approach is to use an application (“app”) in a smartphone, and use Near Filed Communication (NFC) or Bluetooth to connect the glasses and the smartphone after the glasses have been put on, and then to authenticate the user via the app on the smartphone. Even though this way enables an adult user to authenticate the glasses for a child, and thereby circumvent the mandatory constraints, this is no different from the situation today when a user can start an adult program on the TV and we have to trust adults to guard children.

It may be important to ensure that a person is authorized to watch e.g. a movie with particular viewing settings. This is performed in box 340, comprising a “Authenticated activation” procedure. In box 340 the user is identified as described above and loading, or retrieving or else way making available, the corresponding profile of the user. This step is in many cases important e.g. in order to ensure that the profile is set to the rightful user and to ensure that certain mandatory constraints are correct, e.g. that a child will have a child profile regardless of which pair of glasses he/she puts on. When the authenticated activation is performed, typically initiated by the user, a user profile tied to a specific user is activated. The user profile may comprise mandatory restriction(s), e.g. not allowing nudity to be shown.

The user may thereafter, in box 330, be given the opportunity to update the profile. If the user is happy with the current profile, flow continues directly to box 380, and the user may start to, for instance, watch a movie (as in box 170 of FIG. 6), using the preferences etc. as defined in his current, not-updated profile. If, however, the user wants to update his profile, flow continues to box 350. The user connects an input device, e.g. a smartphone or a keyboard, to the MDM unit 10, in order to swiftly be able to input the desired updates to the profile, e.g. in a similar manner as when a user first registers to the system, as described in FIG. 6, boxes 130 and 140. In box 360, the user may, for example, want to update preferences related to a specific game or movie. This in turn may involve setting priority for certain adult content, if a certain alternative perspective should be preferred, if there are news (e.g. sports) that shall be shown to the user, and/or his/her preference with respect to ads. In other embodiments, such information may be (pre-)set already in the user profile. The flow continues to box 370 wherein the system 1, in particular the MDM unit 10 thereof, is updated in view of the provided profile updates.

Flow then continues to box 340, wherein the updated profile is connected to the pair of glasses. Flow ends in box 380, wherein the user is ready to use the services of the system 1.

To further enhance the guarantee that the user matches the profile, the system 1, in particular the MDM unit 10 thereof, may store certain data from previous sessions or from the session when the user was registered. This may comprise the distance between the bows of the glasses (measurable by the size of the glasses and the angle of the frames or hinges/temples) as well as how the nose pressures on the node pads (for a specific model). If those type of data deviates between the activation and previous activations, there are reasons to believe that the indicated user is not correct, and the system might revert to most safe set of mandatory constraints until the system owner has confirmed the users' profile. This might imply that such an anomaly means that the user might not be allowed to see adult content.

A media distribution management unit 10 is provided in various embodiments. The MDM unit 10 may be used for providing multi-content media to one or more users 2a, 2b, . . . , 2x. The MDM 10 is configured to map, in accordance with a respective profile of one or more users 2a, 2b, . . . , 2x, alternative content into a first media stream S1 comprising main content.

The media distribution management unit 10 is configured playback the first media stream S1 comprising the main content and the mapped alternative content.

The media distribution management unit 10 as claimed in claim 1, configured to allocate a respective channel for the respective mapped alternative content.

The media distribution management unit 10 provides a number of advantages. It allows for many dynamic alternative view, shown in an individual, user-selected basis. This is enabled while still using a single screen for all users and provide the same basic content to them all. The MDM unit 10 provides high flexibility in that there does not have to be a fixed relation between a certain video stream and a particular pair of glasses. The MDM unit 10 provides support for mandatory user constraints and thereby provides a desired and safe viewing. Different individual content can be provided to relatively many users simultaneously, even in case of relatively few channels. This gives a highly practical and user-friendly solution.

In an embodiment, the media distribution management unit 10 is configured to allocate, on each allocated channel, the first stream to least one of: a pair of user wearable glasses 3a, 3b, 3c, . . . 3x having a specific polarization, a pair of user wearable glasses 3a, 3b, 3c, . . . 3x having a specific phase of an active shutter mechanism and a specific direction in relation to a screen 4 on which the content is rendered. In the last exemplified channel allocation, a user does not need to wear glasses. Instead, the users' location in relation to the screen determines what he/she is able to see. That is, a user will only be able to watch her/his user specific content when located within the allocated spatial slice. For instance, a user visiting a movie theater and having a reserved seat may receive and see alternative scenes, according to her specific preferences. As another example, in a ride in an amusement park, such as Disneyland, the user position is known during the entire ride, and the user may have one or several screens to watch, depending on position, and the experience may thereby be customized, e.g. in view of characters to see.

In another exemplary use case, the user may be in a sports bar and have his personal seating. When the user needs to briefly leave his place, e.g. in order to order something in the bar, or visit the WC, such movements may be registered, e.g. in relation to a period of time that has been elapsed between leaving the place and returning to it. The system 1 may be configured to provide any sport events or results, that has occurred during this time period, to the user when he has returned to his place. The sport results may, for instance, be provided to the user as text messages.

In a variation of the above embodiment, the media distribution management unit 10 is configured to reallocate the channels for at least two of the users 2a, 2b, . . . , 2x in accordance with their respective profiles and available content.

In an embodiment, the media distribution management unit 10 is configured to reallocate the channels upon determining that a current channel allocation fails to render all required alternative content

In various embodiments, the media distribution management unit 10 is configured to communicate with a screen 4 for showing on each allocated channel the first stream 2a, 2b, . . . , 2x, and the respective alternative content.

In various embodiments, the media distribution management unit 10 is configured to map alternative content in accordance with at least one of: allowable content, forbidden content and additional content.

In variations of the above embodiment, the alternative content comprises one of delayable alternative content and non-delayable alternative content.

In various embodiments, the alternative content comprises one or more of: advertisements, specific type of advertisements, nudity, violence, explicit blood, product placements, updated information on ongoing events, alternative views of a scene, and event highlights. There are various types of events and corresponding information and highlights; an event may be a football match and updated information may then be scores, and event highlight a replay of the goal.

In various embodiments, the media distribution management unit 10 is configured to perform an authentication process before activation of the media distribution management unit 10. When the authentication process is performed, e.g. initiated by the user, a user profile tied to a specific user is activated. The user profile may comprise mandatory restriction(s), e.g. not allowing nudity to be shown. The authentication process may be of any type, for instance being based on one or more of: fingerprint recognition, voice recognition, eye scanning and use of a mobile device for user identification, as described earlier, e.g. in relation to FIG. 9.

FIG. 10 illustrates steps of a method 20 for providing multi-content media to one or more users 2a, 2b, . . . , 2x. The method 20 is performed by a media distribution management unit 10 and is described in various embodiments.

The method 20 comprises, in step 22, mapping in accordance with a respective profile of one or more users 2a, 2b, . . . , 2x, alternative content into a first media stream S1 comprising main content.

The method 20 further comprises, in step 24, playback of the first media stream S1 comprising the main content and the mapped alternative content.

The method 20 comprises various advantages, corresponding to the advantages mentioned in relation to the media distribution management unit 10 throughout the description, e.g. in relation to FIG. 2.

In an embodiment, illustrated in FIG. 10 as an optional step by dashed line, the method 20 comprises allocating 26 a respective channel for the respective mapped alternative content.

In different embodiments, the method 20 comprises allocating on each allocated channel the first stream to at least one of: a pair of user wearable glasses 3a, 3b, 3c, . . . 3x having a specific polarization, a pair of user wearable glasses 3a, 3b, 3c, . . . 3x having a specific phase of an active shutter mechanism and a specific direction in relation to a screen 4 on which the content is rendered.

In variations of the above set of embodiments, the method comprises reallocating the channels for at least two of the users 2a, 2b, . . . , 2x in accordance with their respective profiles and in accordance with available content.

In variations of the above set of embodiments, the method comprises reallocating the channels upon determining that a current channel allocation fails to render all required alternative content. When the demand for alternative content cannot be met with a current channel configuration, then two or more channels need to be reconfigured. Such reconfiguration may, for instance, depend on one or more of: reallocation of channels between users with prioritization depending on the content, delayable content, alternative content prioritization depending on profile (e.g. profiles for children). For the case of localization dependent channel allocation, reconfiguration decisions may rely on the localization of the respective media communication device of each of the users. Exemplary embodiments on how localization may be implemented have been described earlier, and based on e.g. an identification and angle, the user specific content and restrictions may be applied.

In the context of re-allocation, a few examples are given next.

In view of prioritization, a requirement of restricted content for children is more important to meet than immediately providing a sport result to an adult. As another example, if alternative views can be delayed, or alternative overlays can be delayed, that could be prioritized for being delayed, before alternative views that, for some reason, cannot be delayed. When a delayed content approaches its deadline, e.g. is invalid or irrelevant after the deadline (some point of time), its priority gets higher. As still another example, if there are four preferred product placements that should be squeezed into two channels, and none of them can be delayed, there might be certain scheme to select, for instance: based on how often a certain user has obtained product placements, based on if one product placement serves multiple users (primary or secondary interest), based on age categories: one for adults and one for kids.

Alternative views, e.g. a user switching content in order to see a goal being scored, may have a lower priority than alternative content in a common movie or game.

In various embodiments, the method 20 comprises communicating with a screen 4 for showing on each allocated channel the first stream 2a, 2b, . . . , 2x, and the respective alternative content.

In various embodiments, the method 20 comprises mapping alternative content in accordance with at least one of: allowable content, forbidden content and additional content.

In variations of the above set of embodiments, the alternative content comprises one of delayable alternative content and non-delayable alternative content.

In various embodiments, the alternative content comprises one or more of: advertisements, specific type of advertisements, nudity, violence, explicit blood, product placements, updated information on ongoing events, alternative views of a scene, and event highlights.

In various embodiments, the method 20 comprises performing an authentication process before activation of the media distribution management unit 10. As noted earlier, this step ensures that a profile is set to a correct user and thereby ensuring that certain mandatory constraints are indeed set properly.

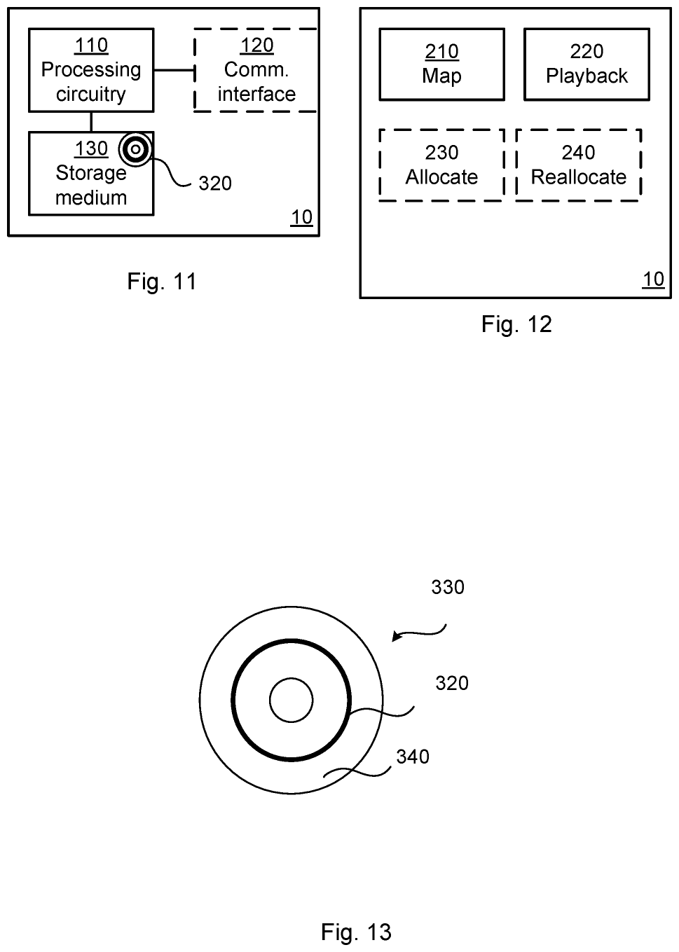

FIG. 11 schematically illustrates, in terms of a number of functional units, the components of a media distribution management unit 10 according to an embodiment. Processing circuitry 110 is provided using any combination of one or more of a suitable central processing unit (CPU), multiprocessor, microcontroller, digital signal processor (DSP), etc., capable of executing software instructions stored in a computer program product 330 (as in FIG. 13), e.g. in the form of a storage medium 130. The processing circuitry 110 may further be provided as at least one application specific integrated circuit (ASIC), or field programmable gate array (FPGA).

Particularly, the processing circuitry 110 is configured to cause the media distribution management unit 10 to perform a set of operations, or steps, as disclosed herein. For example, the storage medium 130 may store the set of operations, and the processing circuitry 110 may be configured to retrieve the set of operations from the storage medium 130 to cause the media distribution management unit 10 to perform the set of operations. The set of operations may be provided as a set of executable instructions. The processing circuitry 110 is thereby arranged to execute methods as disclosed herein.

The storage medium 130 may also comprise persistent storage, which, for example, can be any single one or combination of magnetic memory, optical memory, solid state memory or even remotely mounted memory.

The media distribution management unit 10 may further comprise a communications interface 120 for communications with other entities, nodes, functions, and devices of the system 1. As such the communications interface 120 may comprise one or more transmitters and receivers, comprising analogue and digital components.

The processing circuitry 110 controls the general operation of the media distribution management unit 10 e.g. by sending data and control signals to the communications interface 120 and the storage medium 130, by receiving data and reports from the communications interface 120, and by retrieving data and instructions from the storage medium 130. Other components, as well as the related functionality, of the media distribution management unit 10 are omitted in order not to obscure the concepts presented herein.

FIG. 12 schematically illustrates, in terms of a number of functional modules, the components of a media distribution management unit 10 according to an embodiment. The media distribution management unit 10 of FIG. 12 comprises a number of functional modules; a map module 210 configured to perform step 22, and a playback module 220 configured to perform step 24. The media distribution management unit 10 of FIG. 12 may further comprise a number of optional functional modules, such as an allocate module 230 configured to perform step 26 and an reallocate module 240 configured to reallocate the channels for users in accordance with their respective profiles and available content. In general terms, each functional module 210, 220, 230, 240 may be implemented in hardware or in software. Preferably, one or more or all functional modules 210, 220, 230, 240 may be implemented by the processing circuitry 210, possibly in cooperation with the communications interface 120 and the storage medium 130. The processing circuitry 110 may thus be arranged to fetch, from the storage medium 130, instructions as provided by a functional module 210, 220, 230, 240 and to execute these instructions, thereby performing any steps of the media distribution management unit 10 as disclosed herein.

FIG. 13 shows one example of a computer program product 330 comprising computer readable means 340. On this computer readable means 340, a computer program 320 can be stored, which computer program 320 can cause the processing circuitry 110 and thereto operatively coupled entities and devices, such as the communications interface 120 and the storage medium 130, to execute methods according to embodiments described herein. The computer program 320 and/or computer program product 330 may thus provide means for performing any steps of the media distribution management unit 10 as herein disclosed.

In the example of FIG. 13, the computer program product 330 is illustrated as an optical disc, such as a CD (compact disc) or a DVD (digital versatile disc) or a Blu-Ray disc. The computer program product 330 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 330.

A system 1 is provided, which comprises a media distribution management unit 10 for providing multi-content media to one or more users 2a, 2b, . . . , 2x as has been described herein. The system 1 may, as has also been described, comprise one or more function units 11, 12, 13, 14 of the MDM unit 10. It is noted that one or more of these function units 11, 12, 13, 14 may be implemented in a cloud computing environment, i.e. not all of them need to be part of a physical MDM unit 10. The system 1 may comprise one or more function units 11, 12, 13, 14 of the MDM unit 10 configured to perform the herein provided methods.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A media distribution management unit for providing multi-content media to one or more users, the media distribution management unit being configured to:
map, in accordance with a respective profile of one or more users, alternative content into a first media stream comprising main content, and
playback the first media stream comprising the main content and the mapped alternative content.

2. The media distribution management unit as claimed in claim 1, configured to allocate a respective channel for the respective mapped alternative content.

3. The media distribution management unit as claimed in claim 2, configured to allocate on each allocated channel the first stream to least one of: a pair of user wearable glasses having a specific polarization, a pair of user wearable glasses having a specific phase of an active shutter mechanism and a specific direction in relation to a screen on which the content is rendered.

4. The media distribution management unit as claimed in claim 3, configured to reallocate the channels for at least two of the users in accordance with their respective profiles and available content.

5. The media distribution management unit as claimed in claim 4, configured to reallocate the channels upon determining that a current channel allocation fails to render all required alternative content.

6. The media distribution management unit as claimed in claim 1, configured to communicate with a screen for showing on each allocated channel the first stream, and the respective alternative content.

7. The media distribution management unit as claimed in claim 1, configured to map alternative content in accordance with at least one of: allowable content, forbidden content and additional content.

8. The media distribution management unit as claimed in claim 7, wherein the alternative content comprises one of delayable alternative content and non-delayable alternative content.

9. The media distribution management unit as claimed in claim 1, wherein the alternative content comprises one or more of: advertisements, specific type of advertisements, nudity, violence, explicit blood, product placements, updated information on ongoing events, alternative views of a scene, and event highlights.

10. The media distribution management unit as claimed in claim 1, configured to perform an authentication process before activation of the media distribution management unit.

11. A method for providing multi-content media to one or more users, the method comprising:
mapping, in accordance with a respective profile of one or more users, alternative content into a first media stream comprising main content, and
playback of the first media stream comprising the main content and the mapped alternative content.

12. The method as claimed in claim 11, comprising allocating a respective channel for the respective mapped alternative content.

13. The method as claimed in claim 12, comprising allocating on each allocated channel the first stream to at least one of: a pair of user wearable glasses having a specific polarization, a pair of user wearable glasses having a specific phase of an active shutter mechanism and a specific direction in relation to a screen on which the content is rendered.

14. The method as claimed in claim 13, comprising reallocating the channels for at least two of the users in accordance with their respective profiles and available content.

15. The method as claimed in claim 14, comprising reallocating the channels upon determining that a current channel allocation fails to render all required alternative content.

16. The method as claimed in claim 11, comprising communicating with a screen for showing on each allocated channel the first stream, and the respective alternative content.

17. The method as claimed in claim 11, comprising mapping alternative content in accordance with at least one of: allowable content, forbidden content and additional content.

18. The method as claimed in claim 17, wherein the alternative content comprises one of delayable alternative content and non-delayable alternative content.

19. (canceled)

20. The method as claimed in claim 11, comprising performing an authentication process before activation of the media distribution management unit.

21. A computer program product for providing multi-content media to one or more users, the computer program product comprising a non-transitory computer readable medium storing computer code which, when run on processing circuitry of a media distribution management unit, causes the media distribution management unit to:
map, in accordance with a respective profile of one or more users, alternative content into a first media stream comprising main content, and
playback the first media stream comprising the main content and the mapped alternative content.

22. (canceled)

23. (canceled)
